(19) United States
(12) Patent Application Publication
(10) Pub. No.: US 2019/0113040 A1
(43) Pub. Date: Apr. 18, 2019

(54) PNEUMATIC PUMP CONTROL SYSTEM

(71) Applicant: LANDMARC-SLIGO, LLC, Deland, FL (US)

(72) Inventor: Robert WENDLAND, Deland, FL (US)

(21) Appl. No.: 16/163,120

(22) Filed: Oct. 17, 2018

Related U.S. Application Data
(60) Provisional application No. 62/573,480, filed on Oct. 17, 2017.

(51) Int. Cl. F04D 15/02; F04D 27/00

(52) U.S. Cl. CPC F04D 15/0218; F05B 2270/109; F05B 2270/107; F04D 27/008

(57) ABSTRACT

A pneumatic pump control system includes a pump chamber having a top end and a bottom end, an air valve coupled to the top end of the pump chamber, and a discharge tube within the pump chamber. The discharge tube has a first end coupled to the top of the pump chamber, and a second end having a J-shape terminating in an opening facing the top of the pump chamber. An inlet check valve is positioned at the bottom end of the pump chamber to let the liquid into the pump chamber when the air valve is open. A discharge check valve is coupled to the opening of the discharge tube and is configured to open when a liquid level within the pump chamber rises above a predetermined high level. Compressed air introduced into the pump chamber forces the liquid into the discharge tube and out of the pump chamber.

### RELATED APPLICATION

The present invention is related to U.S. Provisional Patent Application Ser. No. 62/573,480 filed Oct. 17, 2017, the entire contents of which are incorporated herein by reference.

### TECHNICAL FIELD

The present invention relates to the field of pneumatic pumps, and, more particularly, to a pneumatic pump control system.

### BACKGROUND

Pneumatic pumps are currently used in oil wells, water wells, landfill leachate wells, and other types of wells. They operate by driving compressed air in a riser pipe within the well which, in turn, pumps liquid back up the riser pipe and out of the well.

A drawback of the pneumatic pumps is that often times air is introduced into the discharge when the well is pumped dry and over discharges. This over discharging causes premature failure of the pump assembly and more frequent maintenance.

It is desirable, therefore, to provide a pneumatic pump control system that prevents air from entering the discharge and over discharging, and can signal the end of operation.

### SUMMARY

In a particular embodiment, a pneumatic pump control system is disclosed. The system includes a pump chamber having a top end and a bottom end, an air valve coupled to the top end of the pump chamber, and a discharge tube within the pump chamber extending from the top end towards the bottom end of the pump chamber. The discharge tube has a first end coupled to the top end of the pump chamber, and a second end having a J-shape terminating in an opening facing the top end of the pump chamber.

The system also includes a discharge ball check valve coupled to the opening and configured to open when a liquid level within the pump chamber rises above the opening. An inlet check valve is positioned below the second end of the discharge tube and is configured to open to let the liquid into the pump chamber when the air valve is open to allow air to exit the pump chamber. The inlet check valve is also configured to close when compressed air is introduced into the pump chamber through the air valve. The compressed air forces the liquid into the opening of the discharge tube and out of the pump chamber when the discharge ball check valve is open.

The system may also include an air compressor coupled to the air valve and configured to pump the compressed air into the pump chamber. The inlet check valve may include a weighted ball and inlet cage securing the weighted ball therein to limit upward movement. The inlet check valve is configured to prevent liquid from flowing into or out of the pump chamber when the air valve is closed, and the weighted ball is heavier than the liquid.

The inlet check valve may include an inlet opening connecting an interior of the pump chamber to outside of the pump chamber, and the weighted ball may have a size and shape to be seated over the inlet opening to seal the opening. The inlet check valve may also include a screen to prevent debris from entering the pump chamber. The inlet check valve may be one of a ball check valve, swing check valve, stop-check valve, and silent check valve. In addition, the system may include a float switch in electrical communication with the air compressor.

In another aspect, a pneumatic pump control system may include a pump chamber having a top end and a bottom end, an air valve coupled to the top end of the pump chamber, a discharge tube within the pump chamber extending from the top end towards the bottom end of the pump chamber and having a discharge check valve coupled thereto, an inlet check valve positioned at the bottom end of the pump chamber and configured to open to let liquid into the pump chamber when the air valve is open to allow air to exit the pump chamber and configured to close when compressed air is introduced into the pump chamber through the air valve, and an air compressor coupled to the air valve and configured to pump the compressed air into the pump chamber.

In yet another aspect, a method of operating a pneumatic pump control system comprising a pump chamber having a top end and a bottom end, an air valve coupled to the top end of the pump chamber, a discharge tube within the pump chamber extending from the top end towards the bottom end of the pump chamber, a discharge check valve coupled to the discharge tube within the pump chamber, and an inlet check valve at the bottom end of the pump chamber, is disclosed.

The method includes opening the air valve to cause liquid to flow into the pump chamber through the inlet check valve as air exits the pump chamber through the air valve, and opening the discharge check valve when a liquid level within the pump chamber rises above the discharge check valve. The method also includes closing the air valve to stop the liquid from flowing into the pump chamber when the liquid level in the pump chamber reaches a predetermined high level, which closes the inlet check valve. The method includes introducing compressed air into the pump chamber, and forcing the liquid into the discharge tube and out of the pump chamber as the compressed air displaces the liquid. In addition, the method includes stopping the flow of compressed air into the pump chamber when the liquid level reaches a predetermined low level.

### BRIEF DESCRIPTION OF THE DRAWINGS

FIG. 1 is a schematic cross sectional view of a pneumatic pump control system in accordance with an embodiment of the present invention;

FIG. 2 is a schematic cross sectional view with liquid beginning to enter a pump chamber;

FIG. 3 is a schematic cross sectional view with the rising liquid level in the pump chamber causing a discharge ball check valve to open;

FIG. 4 is a schematic cross sectional view of compressed air being introduced into the pump chamber and causing the liquid in the pump chamber to be discharged through a discharge tube;

FIG. 5 is a schematic cross sectional view of the liquid continuing to be discharged through the discharge tube; and

FIG. 6 is a schematic cross sectional view of the pump chamber being pumped to a level that causes the discharge ball check valve to close before the pump chamber is dry.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

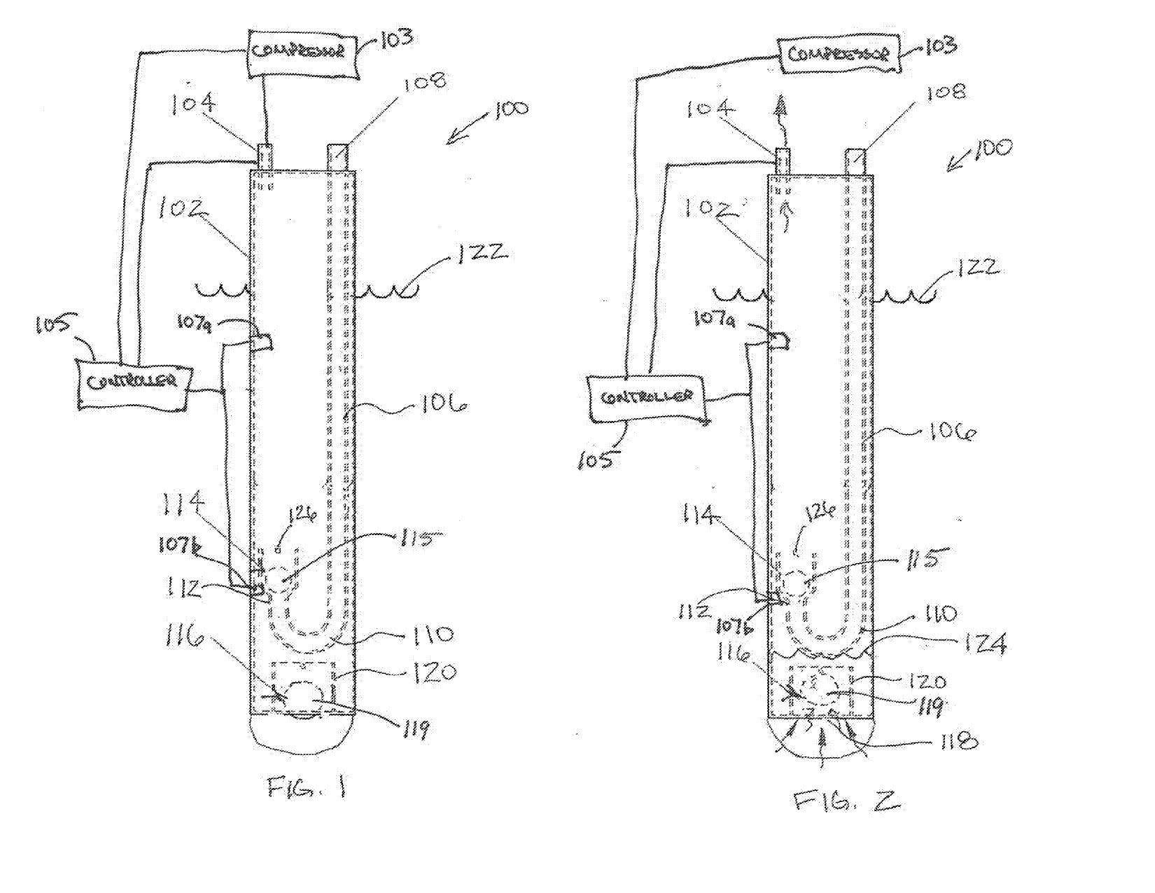

Referring now to FIGS. 1-6, a schematic cross sectional view of the pneumatic pump control system is shown and designated generally as 100. The pneumatic pump control system 100 includes an elongated pump chamber 102 having a top end and a bottom end. The pump chamber 102 is hollow and may have a cylindrical shape in a particular aspect. At the top end of the pump chamber 102 is an air valve 104. The air valve 104 is configured to be coupled to an air compressor 103 (or other source) to provide compressed air to the inside of the pump chamber 102 as discussed in more detail below. In addition, the air valve 104 is configured to allow air to exit the pump chamber 102 when filling the pump chamber 102 with liquid.

A discharge tube 106 is within the pump chamber 102 and generally extends from the top end down towards the bottom end of the pump chamber 102. The discharge tube 106 has a first end 108 coupled to the top of the pump chamber 102, and a second end 110 having a J-shape terminating in an opening 112 facing the top of the pump chamber 102.

A discharge check valve 114 such as a ball check valve 114 is positioned above the opening 112 and is configured to float open (or otherwise open) when a liquid level 124 within the pump chamber 102 rises above the opening 112. When the discharge check valve 114 is open, liquid within the pump chamber 102 can enter the discharge tube 106 and be pumped out of the pump chamber 102 through the first end 108. As those of ordinary skill in the art can appreciate, the discharge check valve 114 can include any type of valve in addition to a ball check valve described herein that is configured to open and close in response to the liquid level.

In order for liquid to enter the pump chamber 102, an inlet check valve 116 is positioned below the second end 110 of the discharge tube 106 and is configured to open to let the liquid into the pump chamber 102 when the air valve 104 is open, which allows air to exit the pump chamber 102 as the liquid displaces the air. As long as the air valve 104 is closed (or compressed air is being introduced into the pump chamber 102), liquid cannot enter the pump chamber 102 through the inlet check valve 116.

Accordingly, the inlet check valve 116 is configured to close when the air valve 104 is closed or compressed air is introduced into the pump chamber 102 through the air valve 104. The inlet check valve 116 may comprise a ball check valve having a weighted ball 119 that has sufficient weight to sink down to cover the inlet 118 when the air valve 104 is closed or introducing compressed air into the pump chamber 102 even when the liquid level 124 is above the inlet check valve 116. An inlet cage 120 around the inlet 118 prevents the weighted ball 119 from moving too upward or far from the opening 120 but allows liquid to push it upwards and to the side in a wobbling type motion as the liquid rushes into the pump chamber 102. As those of ordinary skill in the art can appreciate, the inlet check valve 116 can include any type of check valve in addition to a ball check valve such as a swing check valve, a stop-check valve, or a silent check valve, for example.

The discharge check valve 114 may include a float 115 that is configured to rise and sink with the level of the liquid level 124 in contrast with the weighted ball 119 of the inlet check valve 116 (or other similar one-way check valves known to those of ordinary skill in the art). A discharge cage 126 around the float 115 is configured to prevent the float 115 from floating away and the discharge cage 126 guides the float 115 to cover and seat in the opening 112.

The compressed air forces the liquid into the opening 120 of the discharge tube 106 and out of the pump chamber 102 when the discharge ball check valve 114 is open. The compressed air displaces the liquid in the pump chamber 102.

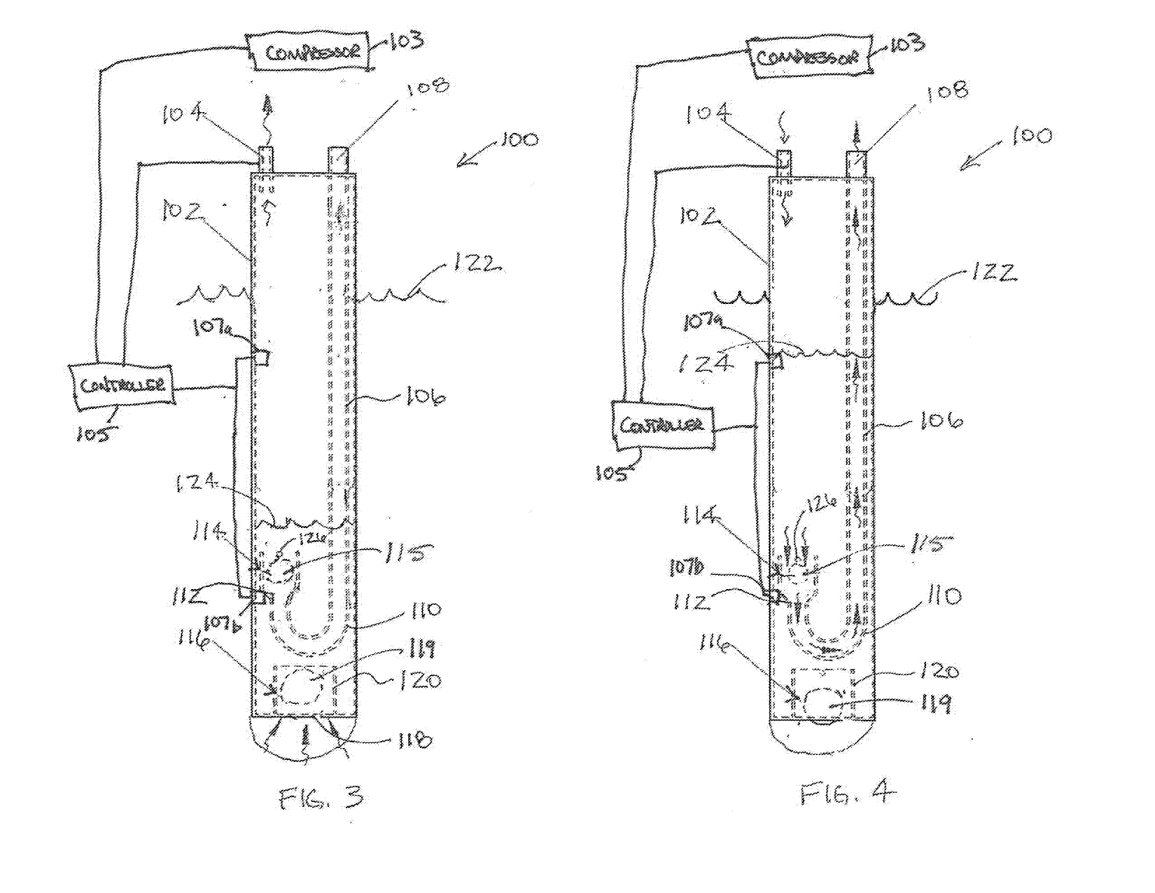

In operation, the pneumatic pump control assembly 100 is placed into an area where liquid is desired to be removed as shown in FIG. 1. This could be down a well or within a landfill having a high water level 122, for example. Moving to FIG. 2, the air valve 104 is opened, allowing liquid to rush in through the inlet 118 and past the inlet check valve 116 into the pump chamber 102. The liquid level 124 continues to rise as shown in FIG. 3, and the float 115 of the discharge check valve 114 floats upwards.

Once the liquid level 124 reaches the desired pre-determined high level in the pump chamber 102, as shown in FIG. 4, a float switch 107a coupled to a controller 105 may begin to cause the compressed air to be introduced into the pump chamber 102 through the air valve 104. This action (in addition to the air valve 104 not allowing air to escape from the pump chamber 102) causes the inlet check valve 116 to close to prevent liquid flowing in (or out) of the pump chamber 102 through the inlet 118. The float 115 of the discharge check 114 valve is no longer covering the opening 112 so that liquid can enter the discharge tube 106 and be pumped out of the pump chamber 102.

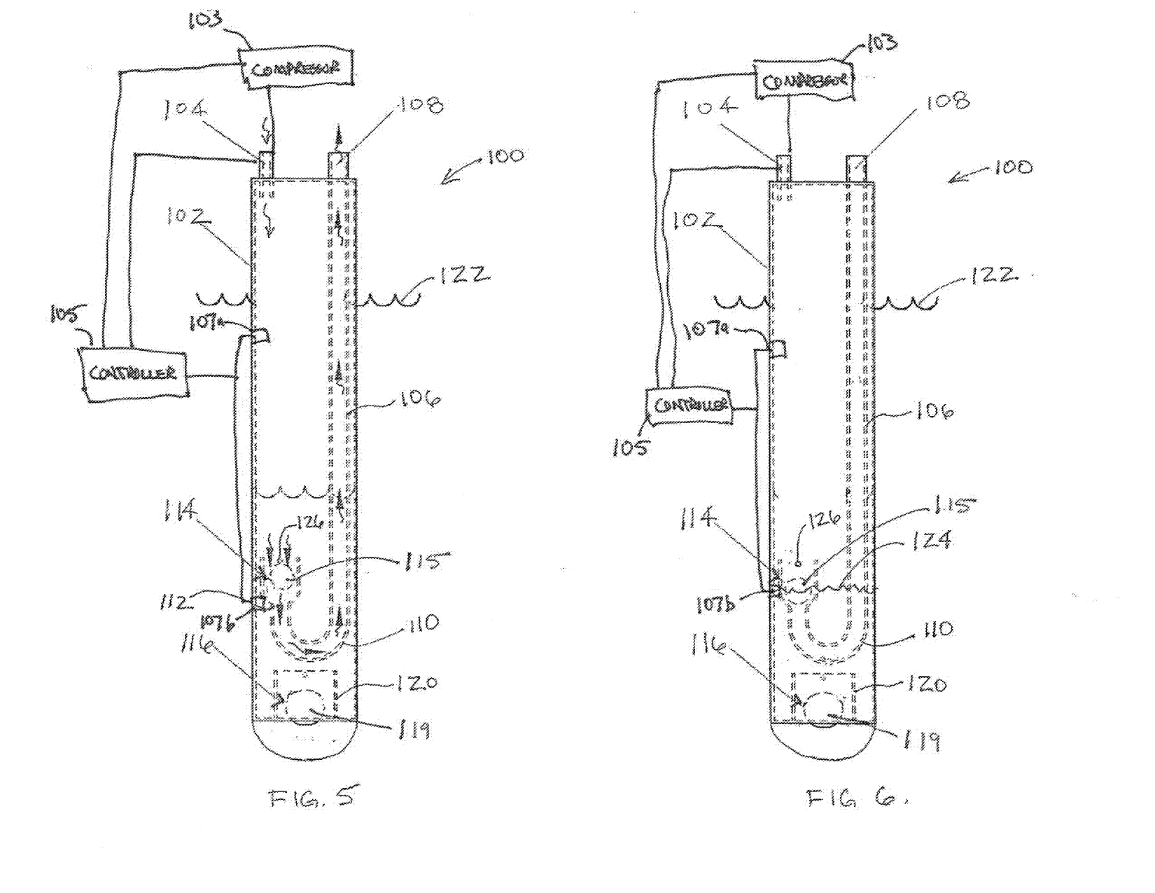

The compressed air continues to be introduced into the pump chamber 102 as shown in FIG. 5, which results in the liquid level 124 continuing to lower inside the pump chamber 102. Once the pump liquid level reaches the discharge ball check valve 114, as shown in FIG. 6, the float 115 covers the opening 112 so that no more liquid can be pumped from the pump chamber 102 and the compressed air is stopped. A float switch 107b positioned at the low level and coupled to the controller 105 may trigger stopping the compressed air. This prevents over discharging and damaging the pumping equipment by the introduction of air into the discharge tube 106, for example.

The controller 105 then opens the air valve 104 to allow liquid to enter the pump chamber 102 again, as shown in FIG. 2, and the process repeats. The cycling of the compressed air and the operation of the air valve 104 can be controlled by the controller 105, timer, or a level (float) switch in the pump chamber 102, or any combination thereof, or other means known to those of ordinary skill in the art.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A pneumatic pump control system comprising:
a pump chamber having a top end and a bottom end;
an air valve coupled to the top end of the pump chamber;
a discharge tube within the pump chamber extending from the top end towards the bottom end of the pump chamber, the discharge tube having a first end coupled to the top end of the pump chamber, and a second end having a J-shape terminating in an opening facing the top end of the pump chamber;
a discharge ball check valve coupled to the opening and configured to open when a liquid level within the pump chamber rises above the opening; and
an inlet check valve positioned below the second end of the discharge tube and configured to open to let the liquid into the pump chamber when the air valve is open to allow air to exit the pump chamber, and configured to close when compressed air is introduced into the pump chamber through the air valve;
wherein the compressed air forces the liquid into the opening of the discharge tube and out of the pump chamber when the discharge ball check valve is open.

2. The pneumatic pump control system of claim 1, further comprising an air compressor coupled to the air valve and configured to pump the compressed air into the pump chamber.

3. The pneumatic pump control system of claim 1, wherein the inlet check valve comprises a weighted ball and inlet cage securing the weighted ball therein to limit upward movement.

4. The pneumatic pump control system of claim 1, wherein the inlet check valve is configured to prevent liquid from flowing into or out of the pump chamber when the air valve is closed.

5. The pneumatic pump control system of claim 3, wherein the weighted ball is heavier than the liquid.

6. The pneumatic pump control system of claim 1, wherein the inlet check valve comprises an inlet opening connecting an interior of the pump chamber to outside of the pump chamber, and the weighted ball having a size and shape to be seated over the inlet opening to seal the opening.

7. The pneumatic pump control system of claim 1, wherein the inlet check valve comprises a screen to prevent debris from entering the pump chamber.

8. The pneumatic pump control system of claim 2, further comprising a float switch in electrical communication with the air compressor.

9. The pneumatic pump control system of claim 1, wherein the inlet check valve comprises one of one of a ball check valve, swing check valve, stop-check valve, and silent check valve.

10. A pneumatic pump control system comprising:
a pump chamber having a top end and a bottom end;
an air valve coupled to the top end of the pump chamber;
a discharge tube within the pump chamber extending from the top end towards the bottom end of the pump chamber;
an inlet check valve positioned at the bottom end of the pump chamber and configured to open to let liquid into the pump chamber when the air valve is open to allow air to exit the pump chamber, and configured to close when compressed air is introduced into the pump chamber through the air valve; and
an air compressor coupled to the air valve and configured to pump the compressed air into the pump chamber.

11. The pneumatic pump control system of claim 10, wherein the discharge tube comprises a first end coupled to the top end of the pump chamber, and a second end having a J-shape terminating in an opening facing the top end of the pump chamber.

12. The pneumatic pump control system of claim 10, further comprising a discharge check valve coupled to the opening and configured to open when a liquid level within the pump chamber rises above the opening.

13. The pneumatic pump control system of claim 11, wherein the inlet check valve is positioned below the second end of the discharge tube.

14. The pneumatic pump control system of claim 10, wherein the inlet check valve comprises one of a ball check valve, swing check valve, stop-check valve, and silent check valve.

15. The pneumatic pump control system of claim 10, wherein the inlet check valve comprises a screen to prevent debris from entering the pump chamber.

16. The pneumatic pump control system of claim 10, further comprising a float switch in electrical communication with the air compressor and configured to operate the air compressor.

17. The pneumatic pump control system of claim 12, wherein the discharge check valve comprises one of a ball check valve, swing check valve, stop-check valve, and silent check valve.

18. A method of operating a pneumatic pump control system comprising a pump chamber having a top end and a bottom end, an air valve coupled to the top end of the pump chamber, a discharge tube within the pump chamber extending from the top end towards the bottom end of the pump chamber, a discharge check valve coupled to the discharge tube within the pump chamber, an inlet check valve at the bottom end of the pump chamber, the method comprising:
opening the air valve to cause liquid to flow into the pump chamber through the inlet check valve as air exits the pump chamber through the air valve;
opening the discharge check valve when a liquid level within the pump chamber rises above the discharge check valve;
closing the air valve to stop the liquid from flowing into the pump chamber when the liquid level in the pump chamber reaches a predetermined high level, which closes the inlet check valve;
introducing compressed air into the pump chamber; and
forcing the liquid into the discharge tube and out of the pump chamber as the compressed air displaces the liquid.

19. The method of claim 18, wherein the discharge tube having a first end coupled to the top end of the pump chamber, and a second end having a J-shape terminating in an opening facing the top end of the pump chamber and coupled to the discharge check valve.

20. The method of claim 19, wherein the introducing compressed air into the pump chamber is terminated when the liquid level reaches a predetermined low level.
